(19) United States
(12) Patent Application Publication
(10) Pub. No.: US 2003/0058361 A1
(43) Pub. Date: Mar. 27, 2003

(54) Image sensor and scanner control method for using the same

(75) Inventor: Richard Yang, Hsinchu (TW)

Correspondence Address: BACON & THOMAS, PLLC, 625 SLATERS LANE, FOURTH FLOOR, ALEXANDRIA, VA, 22314

(73) Assignee: MICROTEK INTERNATIONAL INC., Hsinchu (TW)

(21) Appl. No.: 10/046,397

(22) Filed: Jan. 16, 2002

(30) Foreign Application Priority Data
Sep. 27, 2001 (TW) 090124018

(51) Int. Cl. H04N 5/335

(52) U.S. Cl. 348/311

(57) ABSTRACT

An image sensor is proposed, which can output different amount of data according to different resolution modes. The image sensor employs a plurality of photo diodes to convert received optical signals into charges and uses a plurality of sets of transfer gates to move out the charges on the photo diodes. The image sensor uses a plurality of shift registers to receive the charges moved out from the transfer gates and to remove the charges according to two sets of control signals. A floating diffusion node is used to receive the charges on the shift registers for generating electrical signals. The image sensor uses a charge control unit to control whether the output charges from the shift registers are passed onto the floating diffusion node. Because the image sensor uses the charge control unit to control all, ½ or ¼ parts of charges into the floating diffusion node, a scanner with the image sensor can obtain a high quality image when scanning in high resolution modes and run at a high speed when scanning in low resolution modes.

### BACKGROUND OF THE INVENTION

1. Field of Invention

The invention relates to an image sensor and a scanner using the image sensor. In particular, the invention relates to an image sensor that can output different amount of data according to different resolutions.

2. Related Art

Due to the progress in PC (Personal Computer) technology, the CPU (central processing unit) operation speed, major memory (RAM) and auxiliary memory (HDD and CD-ROM) capacities have been increased a lot. The peripheral devices of the computer are also improved very much from the prior art. Taking image scanner as an example, its resolution has been increased from 300˜600 dpi (dots per inch) to more than 2400 dpi. However, with the continuous increase in resolution, if one uses a high-resolution image scanner to scan document in low-resolution formats, the limit of the scanning speed is not on the interface with the PC (there are already high speed interfaces such as 1394 and USB2.0, etc), but on the image sensor (such as CCD, Charge coupled device) with a large amount of pixels. Thus, the high-resolution image scanner needs to wait for the whole data of a scanning line to be transferred out from a shift register of the image sensor even the scanner is running at the low-resolution mode. The scanner then samples the pixels to form a low-resolution image. The scanning speed is, of course, not as fast as conventional low-resolution scanners.

As shown in FIG. 1, a normal linear CCD 10 includes a plurality of photo diodes 11, a transfer gate 12, a shift register 13, a floating diffusion node 14, a clamp 15, and an output buffer amplifier 16. The number of photo diodes 11 is determined by the required resolution. The higher the resolution is, the more photo diodes there are. When a photo diode 11 is exposed, its charges are transferred to the shift register 13 via the transfer gate 12. The CCD 10 uses control signals Φ1 and Φ2 to dispense the charges of the shift register 13 into the floating diffusion node 14. FIG. 2 is a timing diagram showing the control signal Φ1, Φ2, CP and RS. With reference to FIG. 2, the control signal RS is used to clear the charges of the floating capacitor at the floating diffusion node 14, and the control signal CP is used to restrict the electric potential of the clamp 15. Therefore, the time for the CCD 10 to transmit the whole data of a scan line is (number of the photo diodes 11)*(transmission time for each data). For example, a CCD of a scanner with 1200 dpi for an A4-size medium has 10K photo diodes 11. If the transmission time for each data is 600 ns, then it takes about 6 ms (10K*600 ns) to transmit whole data in each scan line. The transmission time for each scan line is the same for the resolution of 300 dpi, 600 dpi, or 1200 dpi. Therefore, when one uses a 1200 dpi scanner to scan documents in the 600 dpi resolution mode, the speed cannot be as fast as a scanner with a highest resolution of 600 dpi.

As shown in FIG. 3, a double shift register linear CCD 20 includes a plurality of photo diodes 11, two transfer gates 22, 22′, two shift registers 23, 23′, a floating diffusion node 14, a clamp 15, and an output buffer amplifier 16. The number of photo diodes 11 is determined by the required resolution. The higher the resolution is, the more photo diodes there are. The control method of the CCD 20 is similar with the CCD 10, but the CCD 20 uses two shift registers 23, 23′ to shift charges. FIG. 4 is a timing diagram showing the control signal Φ1, Φ2, CP and RS. With reference to FIG. 4, if the data rates of output signal at FIG. 4 are same with the data rates of output signal at FIG. 2, the frequency of the control signal Φ1, Φ2 at FIG. 4 is half the frequency of the control signal Φ1, Φ2 at FIG. 2. For example, a CCD of a scanner with 2400 dpi for an A4-size medium has 20K photo diodes 11. If the transmission time for each data is 600 ns, then it takes about 12 ms (20K*600 ns) to transmit whole data in each scan line. The transmission time for each scan line is the same for the resolution of 300 dpi, 600 dpi, or 1200 dpi. Therefore, when one uses a 2400 dpi scanner to scan documents in the 600 dpi resolution mode, the speed cannot be as fast as a scanner with a highest resolution of 600 dpi.

### SUMMARY OF THE INVENTION

In view of the foregoing, an objective of the invention is to provide an image sensor that can provide different amount of data, so that a scanner with the image sensor can obtain a high quality image when scanning in high resolution modes and run at a high speed when scanning in low resolution modes.

To achieve the above objective, the disclosed image sensor includes: a plurality of photo diodes, which converts received optical signals into electrical signals; two sets of transfer gates, which transfer charges on the photo diodes; two shift registers, including a first and a second shift registers to receive charges transferred out by the transfer gates, respectively, and pass out the charges according to control signals; a floating diffusion unit, which receives the charges from the first shift register and the second shift register to produce electrical signals; a charge control unit, which controls whether the output charges of the second shift register is to be passed to the floating diffusion unit; a clamp, which receives the electrical signals from the floating diffusion unit to maintain its potential level; and an output buffer unit, which receives the signals of the clamp and produces output signals.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 shows a structure of a conventional CCD with a single shift register.

FIG. 2 shows a timing diagram of the control signals Φ1, Φ2, RS, CP and the output signal OUTPUT of the CCD in FIG. 1.

FIG. 3 shows a structure of a conventional CCD with two single shift registers. FIG. 4 shows a timing diagram of the control signals Φ1, Φ2, RS, CP and the output signal OUTPUT of the CCD in FIG. 3.

FIG. 5 is a structure of the CCD with double shift registers of the present invention.

FIG. 6 is a timing diagram of the control signals Φ1, Φ2, RS, CP and the output signal when the charge control switch of the CCD in FIG. 5 is OFF.

FIG. 7 is a timing diagram of the control signals Φ1, Φ2, RS, CP and the output signal when the charge control switch of the CCD in FIG. 5 is ON.

FIG. 8 is a structure of the CCD with three shift registers of the present invention.

FIG. 9 is a timing diagram of the control signals Φ1, Φ2, Φ3, Φ4, RS, CP and the output signal when the first, second and third charge control switches of the CCD in FIG. 8 are ON.

FIG. 10 is a timing diagram of the control signals Φ1, Φ2, Φ3, Φ4, RS, CP and the output signal when the first charge control switch of the CCD in FIG. 8 is ON and the second and third charge control switches of the CCD in FIG. 8 are OFF.

FIG. 11 is a timing diagram of the control signals Φ1, Φ2, Φ3, Φ4, RS, CP and the output signal when the first and second charge control switches of the CCD in FIG. 8 are OFF and the third charge control switch of the CCD in FIG. 8 is ON.

FIG. 12 is a flowchart of the scanner control method for a CCD that can provide different amount of data according to different resolution modes.

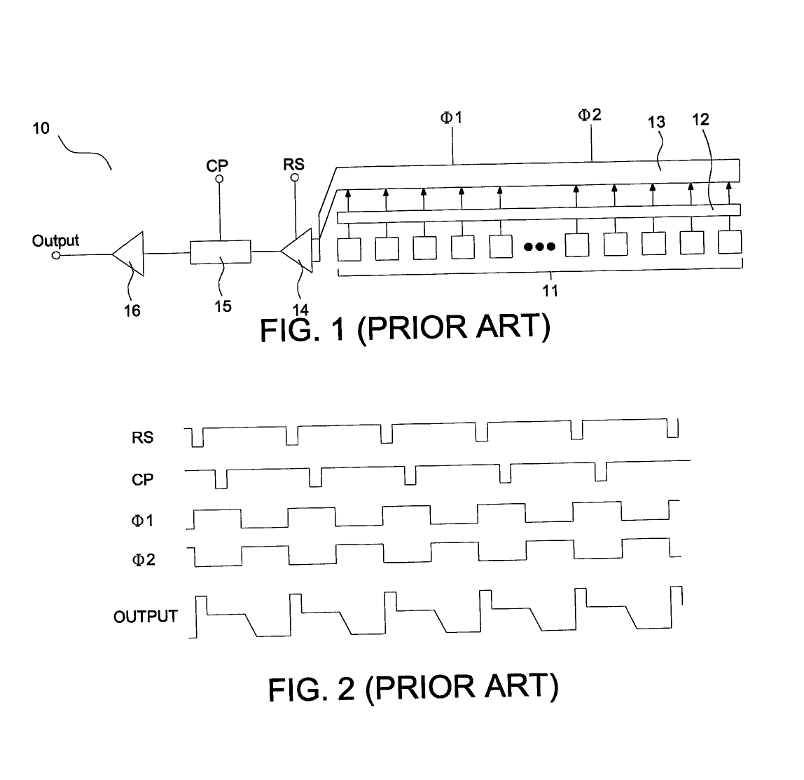

### DETAILED DESCRIPTION OF THE PREFERRED EMBODIMENT

The present invention will be apparent from the following detailed description, which proceeds with reference to the accompanying drawings, wherein the same references relate to the same elements.

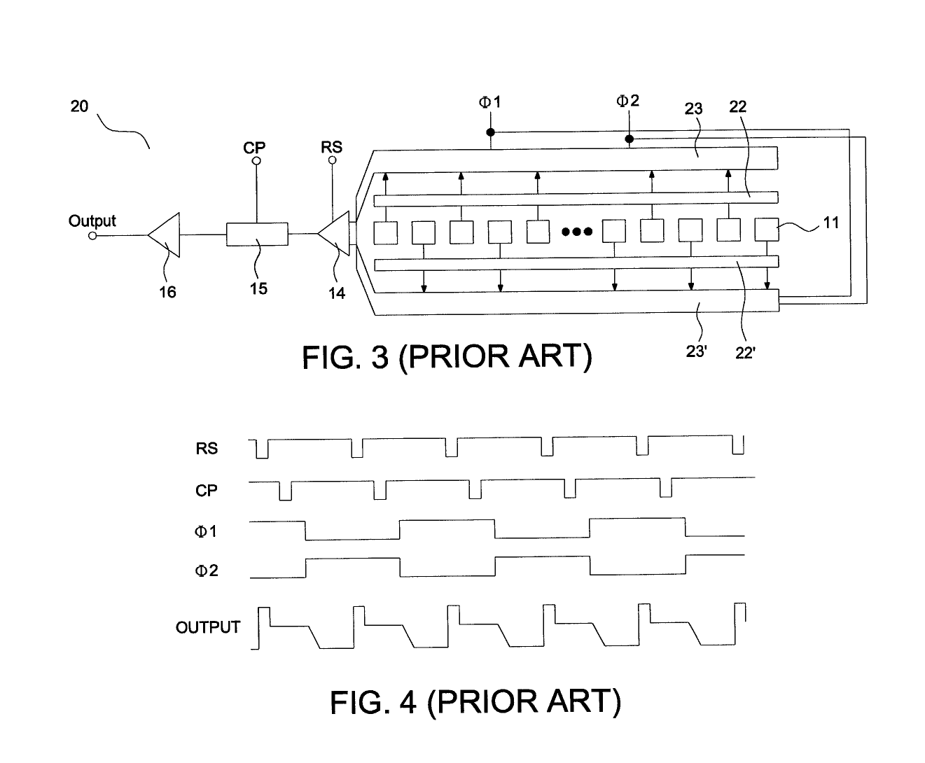

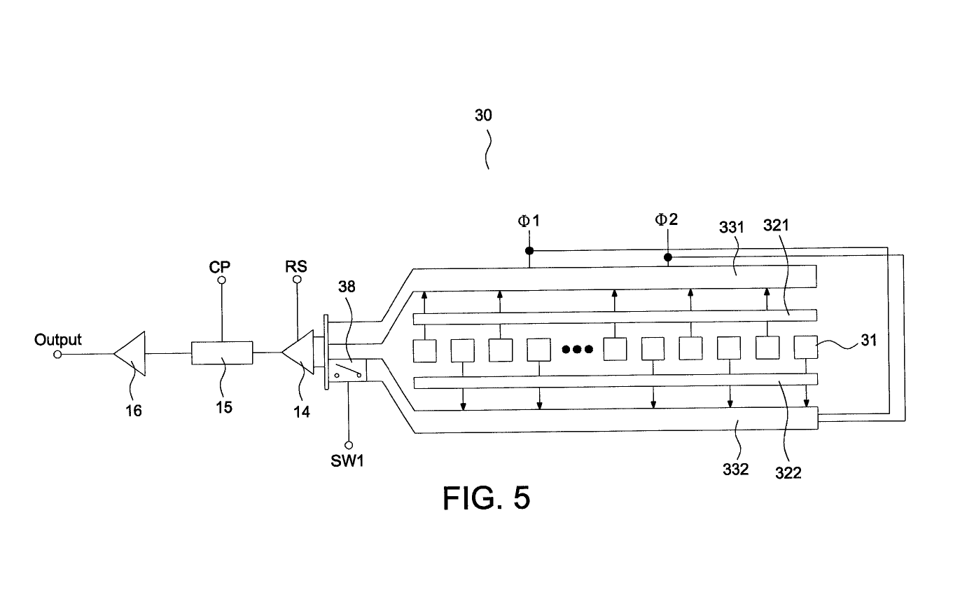

As shown in FIG. 5, the CCD 30 of the present invention is similar to the conventional CCD 20 (see FIG. 3). The CCD 30 also contains several photo diodes 31, two transfer gates 321, 322, two shift registers 331, 332, a floating diffusion node 14, a clamp 15, and an output buffer amplifier 16. The functions and structures of these elements are the same as the same elements in the conventional device and, therefore, are not further described herein. Nonetheless, the disclosed CCD 30 further contains a charge control switch 38 to control the action of moving out charges in the shift register 332. The charge control switch 38 is controlled by the control signal SW. When the control signal SW is enabled, the charge control switch 38 is ON; when the control signal SW is disabled, the charge control switch 38 is OFF.

The output terminal of the first shift register is connected to the floating diffusion node 14, and the output terminal of the second shift register 332 is connected to the floating diffusion node 14 via the charge control switch 38. Thus, when the charge control switch 38 is OFF, only the charges on the first shift register 311 are output to the floating diffusion node 14. When the charge control switch 38 is set ON, the charges on both the first shift register 311 and the second shift register 332 are output into the floating diffusion node 14. When one uses a scanner with the CCD 30 to scan documents, the scanner turns on the charge control switch 38 when the scanning resolution is over 1/2, obtaining all data. If the resolution is below 1/2, the charge control switch 38 is set OFF and the scanner just obtains half of the data for each scanning line to save half of the data reading time.

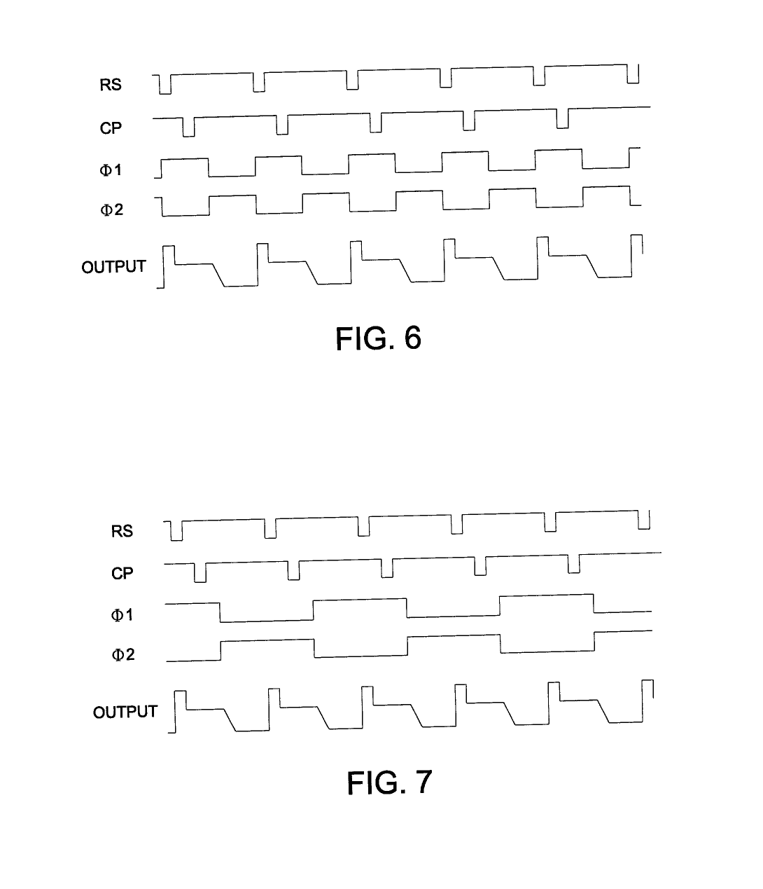

With reference to FIG. 6, the control signal SW is disabled in this case. At the case, only the charges on the first shift register 331 will be moved into the floating diffusion node 14 according to the control signals Φ1 and Φ2. Since only the charges on the first shift register 331 are processed, the frequency of the control signals Φ1 and Φ2 is the same the frequency of the output signal.

With reference to FIG. 7, the control signal SW is enabled in this case. At the case, the charges both on the first and second shift registers 331, 332 will be moved into the floating diffusion node 14 according to the control signals Φ1 and Φ2. Since the charges on both the first and second shift registers 331, 332 are processed, the frequency of the control signals Φ1 and Φ2 is half of the frequency of the output signal.

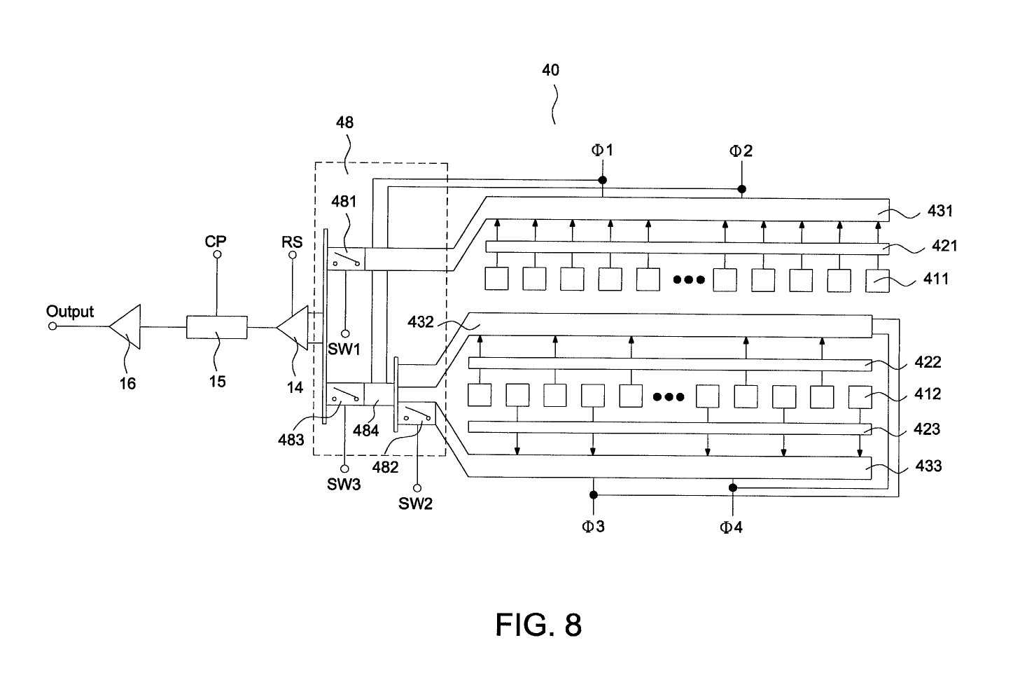

FIG. 8 is the structure of the CCD with three shift registers of the second embodiment of the present invention. As shown in FIG. 8, the CCD 40 includes two sets of separate pluralities of photo diodes 411, 412, three sets of transfer gates 421, 422, 423, three shift registers 431, 432, 433, a floating diffusion node 14, a clamp 15, an output buffer amplifier 16, and a charge control unit 48. Aside from the charge control unit 48, the functions and structures of the other elements are the same as those in the prior art and therefore are not further described herein. The charge control unit 48 contains charge control switches 481, 482, 483 and a charge shift register 484. The charge control switches 481, 482, 483 are controlled by switch signals SW1, SW2, SW3. In this embodiment, the control signals for the shift registers 431, 432, 433, 484 can be grouped into two sets, one being the control signals Φ1 and Φ2, and the other being the control signals Φ3 and Φ4. The charge shift register 484 is controlled by the first set of control signals Φ1 and Φ2.

The first shift register 431 is connected to the floating diffusion node 14 via the first charge control switch 481 and is controlled by the first set of control signals Φ1 and Φ2. The second shift register 432 is connected to the charge shift register 484, and the third shift register 433 is connected to the charge shift register 484 via the second charge control switch 482. The charge shift register 484 is connected to the floating diffusion node 14 via the third charge control switch 483. The second shift register 432 and the third shift register 433 are controlled by the second set of control signals Φ3 and Φ4.

Therefore, when a scanner uses the CCD 40 as its image sensor and the scanning resolution of the scanner is above 1/2, the scanner sets the first, second and third charge control switches 481, 482, and 483 ON. In this case, all data in each scan line are obtained. When the scanning resolution is set between 1/4 to 1/2, the scanner turns the third charge control switch 483 off and turns the first and second charge control switches 481 and 482 on. In this case, only half of the data in each scan line are obtained, therefore the scanner can save half of the data reading time. Furthermore, when the resolution of the scanner goes below 1/4, the scanner turns the first and second charge control switches 481 and 482 off, and leaves the third charge control switch on. In this case, only 1/4 of the data in each scan line are obtained, therefore the scanner can save 1/4 of the data reading time.

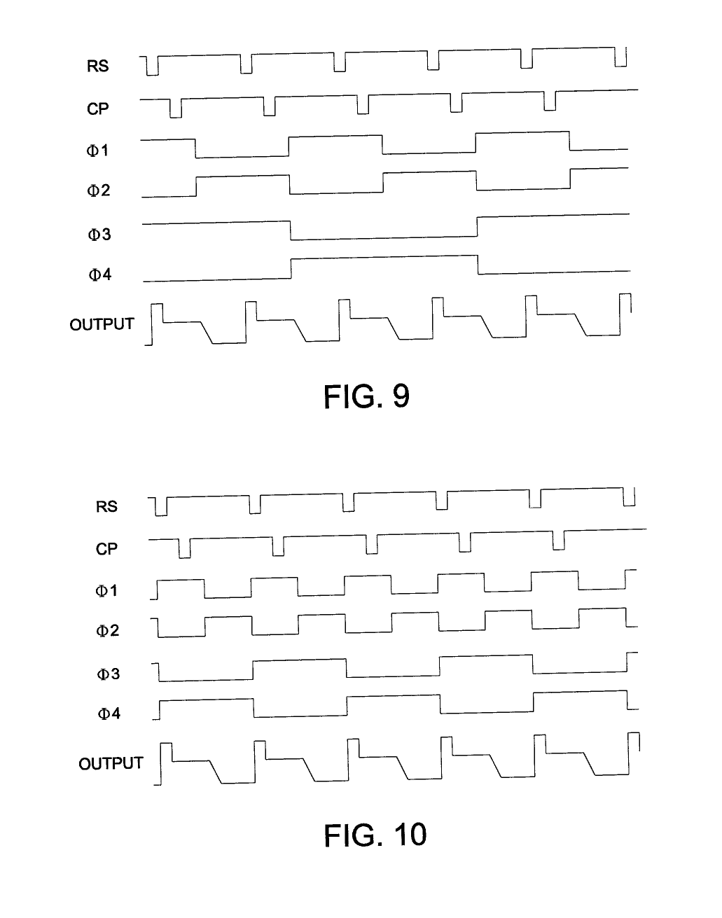

FIG. 9 is a timing diagram of the control signals Φ1, Φ2, Φ3, Φ4, RS, CP and the output signal when the first, second and third charge control switches of the CCD in FIG. 8 are ON. In FIG. 9, the control signals SW1, SW2, SW3 are enabled. In this case, the charges on the first, second and third shift registers 431, 432 and 433 are moved to the floating diffusion node 14 according to the control signals Φ1, Φ2, Φ3, and Φ4. Since the charges on the first, second and third shift registers 431, 432 and 433 are to be processed, the frequency of the first set of control signals Φ1 and Φ2 is set to half that of the output signal, while the frequency of the second set of control signals Φ3 and Φ4 is set to 1/4 of the frequency of the output signal.

FIG. 10 is a timing diagram of the control signals Φ1, Φ2, Φ3, Φ4, RS, CP and the output signal when the first charge control switch of the CCD in FIG. 8 is ON and the second and third charge control switches of the CCD in FIG. 8 are OFF. In FIG. 10, the control signals SW1 is enabled and the control signals SW3 is disabled. In this case, only the charges on the first shift registers 431 are moved into the floating diffusion node 14 according to the control signals Φ1, Φ2, Φ3, and Φ4. Since only the charges on the first shift registers 431 are to be processed, the frequency of the first set of control signals Φ1 and Φ2 are same with the frequency of the output signal, while the frequency of the second set of control signals Φ3 and Φ4 is set to half of the frequency of the output signal.

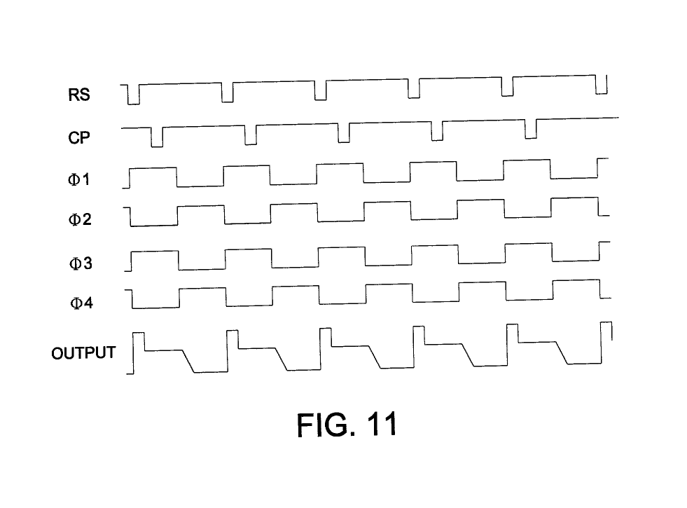

FIG. 11 is a timing diagram of the control signals Φ1, Φ2, Φ3, Φ4, RS, CP and the output signal when the first and second charge control switches of the CCD in FIG. 8 are OFF and the third charge control switch of the CCD in FIG. 8 is ON. In FIG. 11, the control signals SW1 and SW2 are disabled and the control signals SW3 is enabled. In this case, only the charges on the second shift registers 432 are moved into the floating diffusion node 14 according to the control signals Φ1, Φ2, Φ3, and Φ4. Since only the charges on the second shift registers 432 are to be processed, the frequency of the first and second sets of control signals Φ1, Φ2, Φ3 and Φ4 are same with the frequency of the output signal.

Since the disclosed CCD 30, 40 can provide different amount of data according to different resolution requirements, therefore the data processing time is shorter when scanning in the lower resolution mode to increase the scanning speed.

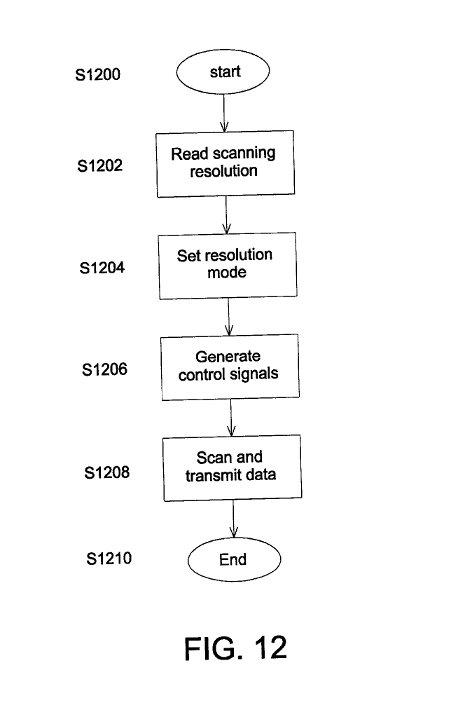

As shown in FIG. 12, the disclosed control method adjusts the frequencies of the control signals according to different resolution modes to achieve the high speed scanning in lower resolution modes. The control method includes the following steps:

Step S1202: Read the scanning resolution inputted by user.

S1204: Set the resolution mode. In accordance with the scanning resolution and the highest optical resolution of the CCD, a resolution mode is determined. When the scanning resolution is greater than 1/2 of the highest optical resolution, the scanner is set at the highest resolution mode. When the scanning resolution is between 1/4 to 1/2 of the highest optical resolution, the scanner is set at the 1/2 resolution mode. When the scanning resolution is smaller than 1/4 of the highest optical resolution, the scanner is set at the 1/4 resolution mode.

Step S1206: Generate control signals. The control signals are generated according to different resolution modes. The control signals include the control signals for controlling the shift register of the linear image sensor, the switch control signals SW1, SW2, SW3, and other related control signals known in the prior art. The frequencies of these control signals are already described in the previous paragraphs and not further detailed hereinafter.

Step S1208: Scan a document and transmit data according to the control signals. This step is similar to a conventional scanner, and thus is not repeated herein.

Step S1210: Finish.

Although the invention has been described with reference to specific embodiments, this description is not meant to be construed in a limiting sense. For example, the embodiments use the structures of two and three shift registers, the scanner can be designed to have more than three shift registers. The disclosed specification uses the control signals Φ1, Φ2, Φ3, and Φ4 to control the movement of the shift registers, but the invention is not limited to these control signals. Any signal that can be used to control the shift register can be applied to the invention. For example, a double shifted control method which combines the charges of adjacent two points into a single charge can be utilized in the invention to achieve an even smaller data capacity requirement.

What is claimed is:

1. An image sensor outputting different amount of data according to different resolution modes, the image sensor comprises:
a plurality of photo diodes for converting received optical signals into charges;
three sets of transfer gates for moving out the charges on the photo diodes;
three shift registers including a first, a second and a third shift registers for receiving the charges moved out from the transfer gates, respectively, and for removing the charges according to two sets of control signals;
a floating diffusion node for receiving the charges on the first, the second and the third shift registers to generate electrical signals;
a charge control unit for controlling whether the output charges from the first, the second and the third shift registers are passed onto the floating diffusion node;
a clamp for receiving the electrical signals generated by the floating diffusion node and maintaining the level within a range; and
an output buffer unit for receiving the signals from the clamp and generating an output signal.

2. The image sensor of claim 1, wherein the charge control unit comprises:
a first charge control switch for controlling whether the output charges on the first shift register are passed onto the floating diffusion node;
a fourth shift register controlled by the first set of control signals for temporarily storing the charges on the second and third shift registers;
a second charge control switch for controlling whether the output charge on the third shift register are passed onto the fourth shift register; and
a third charge control switch for controlling whether the charges on the fourth shift register are passed onto the floating diffusion node.

3. The image sensor of claim 2, wherein the plurality of photo diodes are divided into two sets in equal numbers and are disposed in an upper and a lower rows in an interposed way.

4. The image sensor of claim 3, wherein the first shift register receives data of a set of photo diodes and is controlled by the first set of control signals, and the second and third shift registers receive data of the other set of photo diodes and are controlled by the second set of control signals.

5. The image sensor of claim 4, wherein when the resolution mode is set in the highest resolution mode, the first, second and third charge control switches are turned on to output the data on the three shift registers, and the frequency of the first set of control signals are set as 1/2 of the output signal's frequency and the frequency of the second set of control signals are set as 1/4 of the output signal's frequency.

6. A scanner control method, where the scanner employs an image sensor that provides different amount of data according to different resolution modes, the control method comprising the steps of:
reading a scanning resolution selected by a user;
setting a resolution mode by comparing the read scanning resolution and the highest optical resolution;
generating control signals, which generates shift register control signals, switch control signals and other related control signals in accordance with the resolution mode; and
scanning a document according to the control signals.

7. The method of claim 6, wherein the image sensor is the image sensor described in claim 1.

8. The method of claim 7, wherein the scanner is set in the highest resolution mode when the resolution is greater than 1/2 of the highest optical resolution, the scanner is set in the 1/2 resolution mode when the resolution is between 1/4 and 1/2 of the highest optical resolution, and the scanner is set in the 1/4 resolution mode when the resolution is not greater than 1/4 of the highest optical resolution.

9. The method of claim 8, wherein the step of generating control signals generates two sets of shift register control signals and three switch control signals.

10. The method of claim 9, wherein when the scanner is in the highest resolution mode, the three switch control signals are enabled and the frequency of the first set of control signals are set as 1/2 that of the output signal of the image sensor, and the frequency of the second set of control signals are set as 1/4 that of the output signal.

11. The method of claim 9, wherein when the scanner is in the 1/2 resolution mode, the first switch control signal is enabled and the third switch control signal is disabled, and the frequency of the first set of control signals are set as same with that of the output signal of the image sensor, and the frequency of the second set of control signals are set as 1/2 that of the output signal.

12. The method of claim 9, wherein when the scanner is in the 1/4 resolution mode, the first and second switch control signals are disabled and the third switch control signal is enabled, and the frequency of the first and second set of control signals are set as same with that of the output signal of the image sensor.

13. An image sensor outputting different amount of data according to different resolution modes, the image sensor comprises:
a plurality of photo diodes for converting received optical signals into charges;
a plurality of sets of transfer gates for moving out the charges on the photo diodes;
a plurality of shift registers for receiving the charges moved out from the transfer gates, and removing the charges according to control signals;
a floating diffusion node for receiving the charges on the first, the second and the third shift registers to generate electrical signals;
a charge control unit for controlling whether the output charges from the shift registers are passed onto the floating diffusion node;
a clamp for receiving the electrical signals generated by the floating diffusion node and maintaining the level within a range; and
an output buffer unit for receiving the signals from the clamp and generating an output signal.

14. The image sensor of claim 13, wherein the image sensor has two sets of shift registers and two sets of transfer gates.

15. The image sensor of claim 14, wherein the charge control unit comprises a charge control switch for controlling whether the output charges on one of the shift register are passed onto the floating diffusion node.
